(19) United States
(12) Patent Application Publication
(10) Pub. No.: US 2009/0122583 A1
(43) Pub. Date: May 14, 2009

(54) Corona discharge apparatus

(76) Inventor: Bruce Gelerter, Colorado Springs, CO (US)

Correspondence Address: Matthew Loughran, 172 Lincoln Street, Montclair, NJ, 07042, US

(21) Appl. No.: 11/983,959

(22) Filed: Nov. 13, 2007

(51) Int. Cl. H02M 7/00

(52) U.S. Cl. 363/123

(57) ABSTRACT

An apparatus for producing a corona discharge and a method for producing a corona discharge is described. The apparatus comprises a voltage controlled oscillator (VCO) for producing an audio signal at an adjustable frequency. The VCO is controlled by a ramp generator, and the ramp generator causes the voltage controlled oscillator to continually adjust the frequency of the audio signal. The audio signal modulates a carrier signal produced by a pulse width modulated oscillator and the modulated carrier signal is provided to a coil assembly. The coil assembly is matched to the frequency of the carrier signal and produces a high voltage AC charge from the audio signal. A discharge pin discharges the high voltage AC charge in the form of an ionized corona from the coil assembly.

### BACKGROUND OF THE INVENTION

1. Field of the Invention

The present invention relates to the treatment and management of pain, and more particularly, a corona discharge apparatus suitable for use in medical and veterinary therapy.

2. Description of the Related Art

Thermotherapy is a safe and effective technique for treating various joint and muscle aches related to diseases such as arthritis, lower back pain, joint pain and temporomandibular joint (TMJ) pain. Corona discharge devices may be used by an individual or a healthcare provider to provide a safe, non-invasive thermotherapy treatment to an area of the body that suffers from such pain.

An exemplary corona discharge apparatus is disclosed in U.S. Pat. No. 4,667,677 entitled “Corona Discharge Thermotherapy Technique”, U.S. Pat. No. 5,190,037 entitled “High-power Corona Discharge Beam Thermotherapy System”, and within U.S. Pat. No. 5,317,155 entitled “Corona Discharge Apparatus”, each of the above patents are herein incorporated by reference in their entirety.

Arthritis is a condition which affects 1 out of every 7 people in the United States, and 1 out of every 5 adults. A USA TODAY article estimated that 50 million people in the U.S. suffer from arthritis. Arthritis is also the leading cause of disability for people over the age of 55 and costs the U.S. economy $128 billion annually.

Lower back pain is another leading cause of disability. A PREVENTION magazine article stated that approximately 100 million people in the United States suffer from lower back pain. Americans spend over $50 billion annually on conventional and alternative therapy solutions seeking lower back pain relief.

The worldwide market associated with pain relief solutions is easily in excess of $100 billion dollars. As people live longer, the market for pain relief with aging, arthritis, lower back pain, knees, hips, and joint pain will continue to grow.

Unfortunately, known corona discharge apparatuses have shortcomings which limit their usefulness. Modern day corona discharge apparatuses operate at one set frequency to stimulate nerve cells and treat pain. Nerve cells undergo a phenomenon known as accommodation with each subsequent treatment by the corona discharge apparatus at a particular static frequency. During a therapy or treatment session, each subsequent treatment with the corona discharge apparatus at the static frequency is less effective than prior treatments due to accommodation of the nerve cells to the particular frequency.

Thus, there is a need in the art to provide a corona discharge apparatus that reduces nerve cell accommodation during a therapy session.

### SUMMARY OF THE INVENTION

An apparatus for producing a corona discharge and a method of treating and managing pain with the apparatus is described. The apparatus comprises a voltage controlled oscillator (VCO) for producing an audio signal at a first frequency. The VCO is controlled by a ramp generator, and the ramp generator causes the voltage controlled oscillator to gradually adjust the frequency of the audio signal from the first frequency to a final frequency. The audio signal is placed onto a carrier signal by a modulator and carried to a coil assembly. The coil assembly is matched to the frequency of the carrier signal and produces a high voltage AC charge from the audio signal. A discharge pin discharges the high voltage AC charge in the form of an ionized corona from the coil assembly. By adjusting the frequency of the audio signal produced by the VCO, nerve cells are less likely to accommodate to the thermotherapy treatment from the apparatus. Thus, efficacy of thermotherapy treatment with the apparatus is increased.

The method comprises generating an audio signal at a first frequency, gradually adjusting the audio signal from the first frequency to a final frequency, producing a high voltage AC charge from the gradually adjusted audio signal, and discharging an ionized corona produced from the high voltage AC charge over a treatment area. Treatment with the apparatus may be especially useful for treating TMJ, arthritis, lower back pain, knees, hips, and joint pain. Further, treatment with the apparatus is non-invasive and may be performed on an outpatient basis.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a general overview of a corona discharge apparatus;

FIG. 2 is a cutaway view of a corona discharge gun utilized by the corona discharge apparatus;

FIG. 3 is a schematic diagram of the internal circuitry of the corona discharge apparatus;

FIG. 4 is a top-down view of a coil assembly utilized by the corona discharge apparatus; and

FIG. 5 is a cross-sectional view of the coil assembly utilized by the corona discharge apparatus.

While the invention is described herein by way of example using several embodiments and illustrative drawings, those skilled in the art will recognize that the invention is not limited to the embodiments of drawing or drawings described. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF THE INVENTION

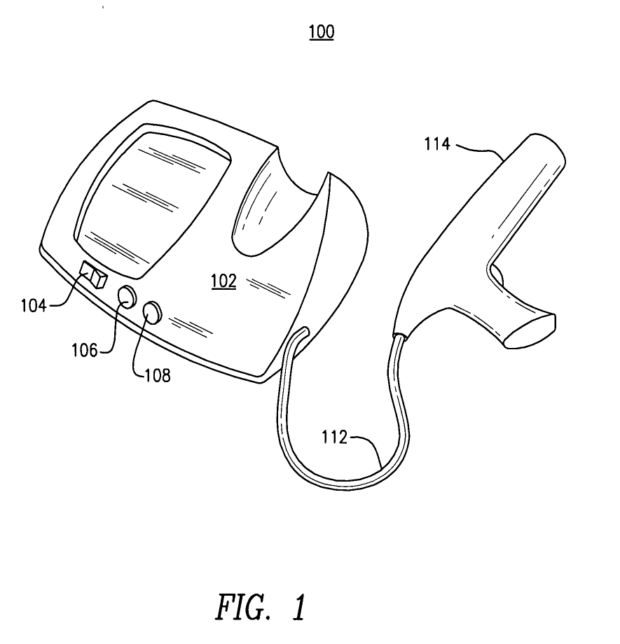

FIG. 1 is a general overview of an exemplary embodiment of a corona discharge apparatus 100. The corona discharge apparatus 100 comprises a control unit 102 coupled to a corona discharge gun 114 by a wire 112. The apparatus 100 is coupled to a power source (not shown) such as a 15 volt power source, standard wall outlet or battery.

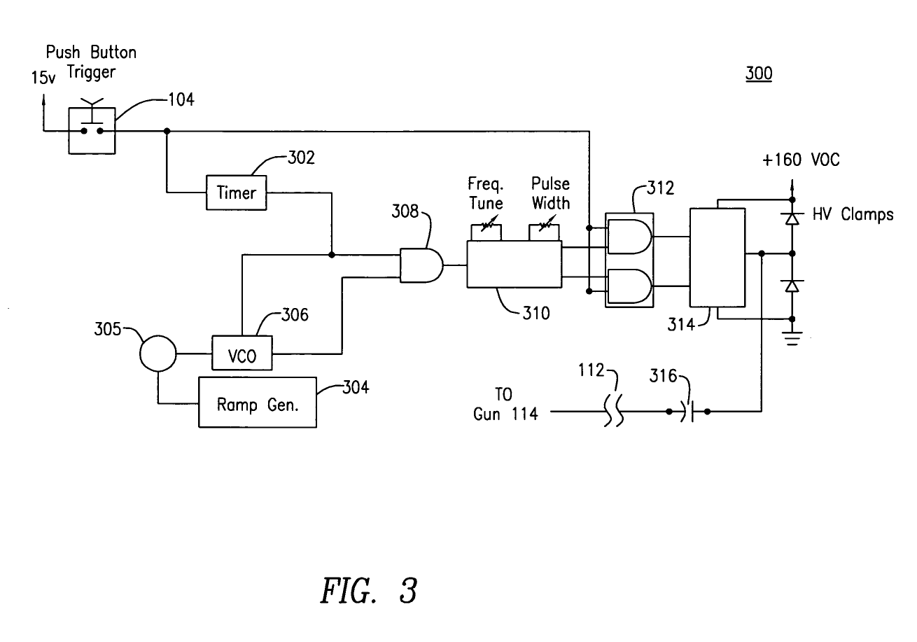

The control unit 102 houses the internal circuitry (shown in FIG. 3) that controls the operation of the apparatus 100. The control unit 102 may be constructed from hard plastic, metal such as steel or aluminum, or any durable substance designed to withstand continual use in either a medical office environment or a harsh environment where animals or horses are housed. An “On/Off” switch 104, power adjustment control 106 and frequency adjustment control 108 are integrated into the control unit 102 to facilitate operation of the apparatus 100. The switches 104/106/108 may be rotary switches, potentiometers, slide switches, toggle switches, push button switches and the like. The control unit 102 is not limited to the controls 104/106/108, and these controls 104/106/108 are only offered as an example of possible controls.

The power switch 106 adjusts the amount of power supplied to the apparatus 100. In one embodiment of the invention, the power switch 106 is a rotary dial with numeral settings of 0 to 10, 0 representing an off position and 10 representing maximum power supplied to the apparatus 100. The apparatus 100 will generate a corona discharge at a higher voltage when the power switch 106 is set to the maximum power setting, i.e., 10. When the power switch 106 is set to a lower power setting, for example a power setting of 3, the apparatus 100 still produces a corona discharge but at a lower voltage.

The frequency adjustment switch 108 is used to adjust and fine tune the frequency of the carrier signal produced by modulator. The modulator is shown in FIG. 3 and discussed in further detail below. The frequency adjustment switch 108 is an optional part of the apparatus 100.

The corona discharge gun 114 is coupled to the control unit 102 by the wire 112. The wire 112 may be an insulated coiled wire or any insulated wire capable of delivering an appropriate current from the control unit 102 to the gun 114. The gun 114 may be made from a hard plastic or the same durable substance as the control unit 102.

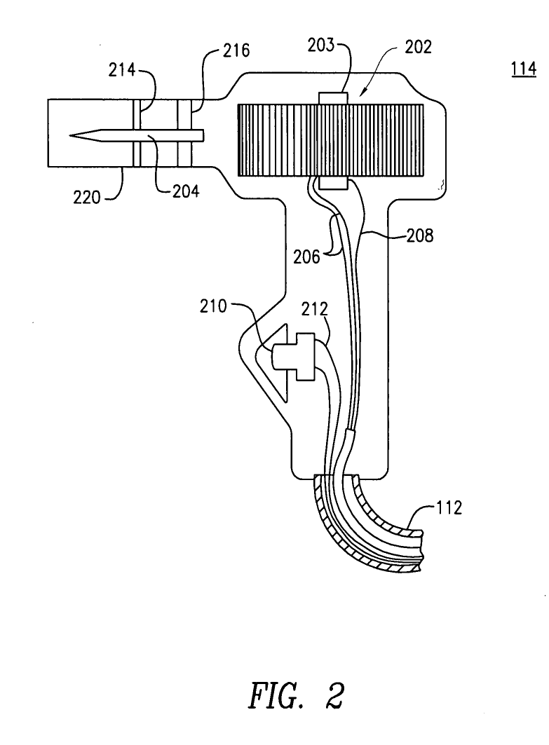

FIG. 2 is a cutaway view of the corona discharge gun 114. The internal circuitry of the gun comprises a coil assembly 202 and assembly core 203, discharge pin 204, resonant circuit node leads 206, a connection to the power supply ground 208, trigger switch 210, trigger wire 212. Also illustrated is the barrel 220 of the gun 114, and insulative support structures 214 and 216. The leads 206 are coupled to the coil assembly 202 and the trigger wire 212 is coupled to the trigger switch 210. The leads 206 and the power supply ground 208 are encased in sheathing for the wire 112. The wire 112 connects the gun 114 to the control unit 102 as shown above in FIG. 2.

FIG. 3 is a schematic diagram of the internal circuitry 300 of the corona discharge apparatus 100. The internal circuitry 300 comprises a timing mechanism 302, a ramp generator 304, an operational amplifier 305, a voltage controlled oscillator (VCO) 306, an enablement gate 308, a pulse width modulated oscillator 310, gating mechanism 312, buffer 314 and capacitor 316. Switch 104 couples the internal circuitry 300 to a power source (not shown). The timing mechanism 302, ramp generator 304, operational amplifier 305, VCO 306, enablement gate 308, modulator 310, gating mechanism 312, buffer 314, and switch 104 reside within the control unit 102 as shown in FIG. 1. The wire 112 connects the internal circuitry 300 of the control unit 102 to the internal circuitry of the gun 114 described above in FIG. 2.

For ease of reference, FIGS. 2 and 3 may be considered together to illustrate the operation of the corona discharge apparatus 100. The apparatus 100 is operated by a user pushing switch 104 to supply power from a power source to the apparatus 100. The power source may be any conventional power source, such as an electrical outlet or a battery, and a suitable amount of power from 10 volts to 110 volts is supplied to the apparatus. The switch 104 may be any conventional switch for connecting the power source to the apparatus 100 such as a push button switch, a trigger switch, a toggle switch and the like.

Pushing the switch 104 triggers the timing mechanism 302. The timing mechanism may be a 5-5-5 or a 5-5-6 timing mechanism. In one embodiment of the invention, the timing mechanism 302 allows for operation of the apparatus for a period of 20 seconds. The timing mechanism acts a failsafe mechanism that helps to prevent overheating of the apparatus 100. The timing mechanism is coupled to the enablement gate 308.

The VCO 306 outputs an audio frequency within a range suitable for therapeutic thermotherapy treatment with the apparatus 100. In one embodiment of the invention, the VCO outputs an audio frequency between 100 Hz and 1 kHz. The VCO 306 may be any conventional voltage controlled oscillator. As the voltage applied to the VCO 306 increases, the audio frequency outputted by the VCO 306 also increases.

The VCO 306 is coupled to the operational amplifier 305 and the operational amplifier 305 is coupled to the ramp generator 304. Suitable ramp generators and operational amplifiers are commercially available from Supertex Corp. of Sunnyvale Calif. The voltage of the ramp generator 304 increases from a minimum starting voltage to a maximum ending voltage over a period of time. At the end of the period of time, the ramp generator 304 resets itself back to the minimum starting voltage and “ramps up” or increases again to the maximum ending voltage. The period of time that the ramp generator takes to ramp up may correspond directly to the amount of time allowed by the timing mechanism 302. For example, if the timing mechanism 302 allows the apparatus to operate for 20 seconds, then the ramp generator will reset from its maximum voltage to its minimum voltage every 20 seconds.

The voltage output by the ramp generator 304 is coupled to the operational amplifier 305, and the operational amplifier 305 is directly coupled to the VCO 306. As the voltage supplied by the ramp generator 304 increases, the voltage supplied to the VCO 306 also increases. The increase in voltage supplied to the VCO 306 causes the frequency of the audio signal supplied by the VCO 306 to continually and gradually increase. However, it should be noted that at some point in time, the ramp generator 304 will reset itself to its minimum voltage. At this point, the audio frequency supplied by the VCO 306 will suddenly decrease to its minimum frequency.

In one embodiment of the invention, the audio frequency supplied by the VCO 306 ranges from 100 Hz to 1 kHZ. When the ramp generator 304 reaches its maximum voltage, the VCO 306 will supply an audio signal at a frequency of 1 kHz. After the ramp generator 304 reaches its maximum voltage, the voltage automatically returns to its minimum voltage and likewise, the VCO 306 will supply an audio signal at a frequency of 100 Hz. In this manner, the audio frequency supplied by the VCO 306 is continually and gradually increasing from a frequency of 100 Hz to 1 kHz, and automatically returning to a frequency of 100 Hz. The audio frequency will continually cycle from a low frequency to a high frequency for the duration of time set by the timing mechanism 302.

The audio frequency supplied by the VCO 306 is passed on to the gating mechanism 308. The gating mechanism 308 is also connected to the timing mechanism 302. The gating mechanism 308 only allows for pass-through of the audio signal when a signal from the timing mechanism 302 is present. For example, if the timing mechanism 302 limits operation of the apparatus 100 for only 20 second intervals, the gating mechanism 308 only allows pass-through of the audio signal supplied by the VCO 306 during that 20 second interval.

The gating mechanism 308 is coupled to the modulator 310. The modulator 310 places the audio signal onto a carrier signal. In one embodiment of the invention, the carrier signal is set to a frequency of approximately 500 kHz. The carrier signal is set to a higher frequency than the audio signal and modulated by the audio signal. The modulator 310 is a pulse width modulator which controls the carrier signal by power adjustment and frequency adjustment. The amplitude of the carrier signal may be increased by increasing the power supplied to the modulator 310, and likewise, the amplitude of the carrier signal may be decreased by decreasing the power. The carrier signal may be turned off completely by setting the frequency of the carrier signal to zero or the “off” position. The carrier signal may also be set to another frequency, e.g., 300 kHz, 800 kHz, etc., that provides more beneficial treatment of a patient.

The modulator 310 is coupled to gating mechanism 312. The gating mechanism 312 receives input signals from the timing mechanism 302 and the modulator 312. The gating mechanism 312 allows pass-through of the audio signal on the carrier signal only when the carrier signal and the signal from the timing mechanism 302 are both present. The gating mechanism 312 provides passage of the audio signal on the carrier signal through to the buffer 314.

The buffer 314 may be a MOSFET driver. The buffer 314 stores the audio signal before passing on the audio signal from the control unit 102 to the corona discharge gun 114.

The capacitor 316 forms a series-resonant circuit with the coil assembly 202 to create a high voltage on the primary winding of the coil assembly. The high voltage on the primary winding is then stepped up to a higher voltage on the secondary winding of the coil assembly 202. In one embodiment of the invention, the capacitor 316 is a 0.0015 microfarad capacitor, and the voltage on the primary winding is 10 kV which is stepped up to 100 kV on the secondary winding of the coil assembly 202.

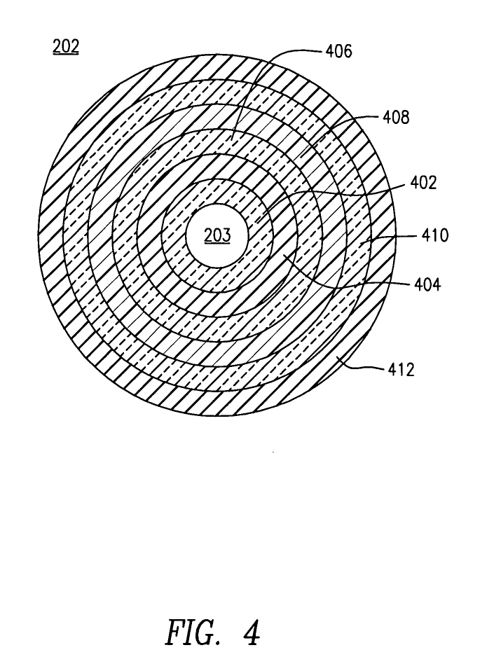

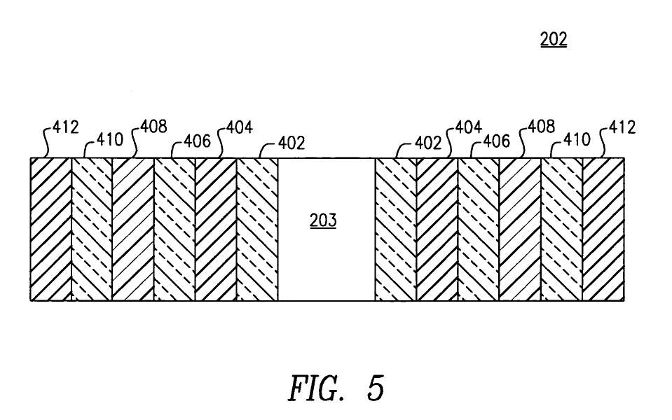

Referring now to FIG. 2, the audio signal is passed on to the coil assembly 202 via resonant circuit node leads 206. The coil assembly 202 is matched to the frequency of the carrier signal produced by the modulator 310. The coil assembly 202 is described in further detail in FIGS. 4 and 5. The coil assembly 202 steps up the voltage from the power source to a voltage sufficient enough to produce a corona discharge from the discharge pin 204.

The coil assembly 202 may step up the voltage from 10 kV to 100 kV or greater. A corona discharge may be produced at 50 kV, and voltages stepped up by the coil assembly 202 to as high as 250 kV are also possible. The corona discharge ionizes the surrounding air, and the electrons in the air seek ground via the path of least resistance. The corona discharge also temporarily heats the surrounding air, allowing for thermotherapy treatment of an area in close proximity to the corona discharge.

FIG. 4 is a top-down view of the coil assembly 202, and FIG. 5 is a cross-sectional view of the coil assembly 202 according to the embodiment of FIG. 2. As shown, the coil assembly is arranged in a substantially radial fashion. In one embodiment of the invention, a substantially cylindrical ferrite core 203 is at the center of the coil assembly 202. The ferrite core 203 is at ground potential, and the voltage increases with increasing distance from the center. The highest voltage is at the outermost portion of the assembly 202. The ferrite core 203 increases the Q, i.e., the inductive reactance, of the coil assembly 202.

FIG. 5 illustrates the construction of the core assembly 202. The ferrite core 203 is at the innermost center of the assembly 202. The ferrite core 203 has a diameter of approximately 1.1 inches and a length of approximately 3 inches. A layer of insulation 402 with an insulation capability of greater than 10 kV, such as insulating tape available from 3M Corp. of St. Paul, Minn., is wrapped around the ferrite core 203. A primary winding 404 of wire is wrapped around the insulation 402 and the ferrite core 203. In one embodiment of the invention, Litz 8/30 wire is utilized for the primary winding 404.

A second layer of high voltage insulating tape 406, made from the same or similar material to the first layer of insulation 402, is wrapped around the primary winding 404. A slipover tube 408 is placed over the ferrite core 203, first insulation layer 402, the primary winding 404 and the second layer of insulating tape 406. The outside of the slipover tube 408 is wrapped in a third layer of high voltage insulating tape 410. The slipover tube may be constructed from polyoxymethylene or DELRIN.

A secondary winding 412 is wrapped around the outside of the slipover tube 408. In one embodiment of the invention, the secondary winding comprises 400 turns of Litz 8/30 wire. In this embodiment, the 400 turns are arranged in 20 layers, 20 turns per layer, each layer being separated from the next by respective layers of high voltage insulating tape. The outer layer of the secondary winding 412 is covered by a final layer of high voltage insulating tape.

Leads 206 are connected to the primary winding 404 and the secondary winding 412 windings. The power supply lead 154 is connected to the primary winding 404. An output lead 172 from the outermost periphery of the secondary winding 412 is coupled to the discharge pin 204, is taken off the outermost periphery of the secondary winding 412.

The relationship between the secondary winding 412 and the primary winding 404 directly affects the amount of power needed to effectively operate the apparatus 100. As disclosed in one embodiment above, the secondary winding 412 has 400 turns and the primary winding 404 has 40 turns, for a turn ratio of 10:1. In another embodiment of the invention, the turn ratio between the secondary winding 412 to the primary winding 404 is 1000:1. Less power is needed to operate the apparatus 100 as the ratio between the secondary winding 412 and the primary winding 404 increases. The apparatus 100 is less likely to overheat when operated at lower power. Therefore, increasing the ratio between the secondary winding 412 and the primary winding 404 is beneficial.

A patient may be treated with the apparatus 100 by placing the corona discharge pin 204 within close proximity of a treatment area. The treatment area is any area affected by joint pain, muscle pain, arthritis, or any condition that may benefit from thermotherapy treatment. The apparatus 100 is set to an appropriate power level via the power adjustment switch 106 and the apparatus 100 is turned on by the on/off switch 104. In one embodiment of the invention, a corona discharge is emitted from the discharge pin 204 on the gun 114 when a user presses the trigger switch 210. In another embodiment of the invention, one or more corona discharges are emitted from the discharge pin 204 on the gun 114 over a period of time set by the timing mechanism 302.

Thus, the present invention provides an effective, non-invasive thermotherapy treatment for joint pain, muscle pain, arthritis and temporomandibular joint (TMJ) disorder. The apparatus utilizes a ramp generator to continually adjust the frequency of an audio signal produced by a voltage controlled oscillator. By continually adjusting the frequency of the audio signal, nerve cells are less likely to accommodate to thermotherapy treatment provided by the apparatus.

While the foregoing is directed to embodiments of the present invention, other and further embodiments of the invention may be devised without departing from the basic scope thereof, and the scope thereof is determined by the claims that follow.

1. An apparatus for producing a corona discharge comprising:
a voltage controlled oscillator for producing an audio signal at a first frequency; and
a ramp generator for gradually increasing voltage supplied to the voltage controlled oscillator causing the audio signal to gradually increase from the first frequency to a final frequency.

2. The apparatus of claim 1, further comprising:
an operational amplifier coupled to the ramp generator and coupled to the voltage controlled oscillator, wherein the operational amplifier supplies increased voltage produced by the ramp generator to the voltage controlled oscillator.

3. The apparatus of claim 2, further comprising:
a timing mechanism for controlling a period of time during which the apparatus is operational; and
an enablement gate for receiving an input from the timing mechanism and the voltage controlled oscillator, wherein the enablement gate only allows pass-through of the audio signal from the voltage controlled oscillator when input from both the timing mechanism and the voltage controlled oscillator are present.

4. The apparatus of claim 3, further comprising:
a modulator for producing a carrier signal to carry the audio signal produced by the voltage controlled oscillator, wherein the carrier signal is of a frequency higher than the frequency of the audio signal and modulated by the audio signal.

5. The apparatus of claim 4, wherein the modulator is a pulse width modulator.

6. The apparatus of claim 4, wherein an amplitude of the carrier signal is adjustable.

7. The apparatus of claim 4, wherein the frequency of the carrier signal is adjustable.

8. The apparatus of claim 4, further comprising:
a gating mechanism coupled to the modulator, wherein the gating mechanism allows pass-through of the modulated carrier signal produced by the modulator; and
a buffer for storing the modulated carrier signal.

9. The apparatus of claim 8, wherein the buffer is a MOSFET driver.

10. The apparatus of claim 8, further comprising:
a coil assembly for stepping up voltage and coupled to the buffer for receiving the modulated carrier signal, wherein the coil assembly is matched to the frequency of the modulated carrier signal.

11. The apparatus of claim 10, wherein the coil assembly comprises:
a ferrite core;
a primary winding of wire around the ferrite core; and
a secondary winding of wire around the primary winding.

12. The apparatus of claim 11, wherein a ratio of the secondary winding to the primary winding is 10:1.

13. The apparatus of claim 11, wherein a ratio of the secondary winding to the primary winding is 10:1.

14. The apparatus of claim 10, further comprising:
a discharge pin coupled to the coil assembly for discharging an electrical charge produced by the coil assembly, wherein the electrical charge ionizes the surrounding air to produce a corona discharge.

15. A method for producing a corona discharge comprising:
producing an audio signal at a first frequency;
gradually increasing the first frequency of the audio signal to a final frequency;
modulating a carrier signal with the audio signal while the frequency of the audio signal is gradually increased from the first frequency to the final frequency; and
utilizing the modulated carrier signal to produce the corona discharge.

16. The method of claim 15, further comprising:
utilizing a timing mechanism to control a period of time; and
allowing modulation of the carrier signal by the audio signal only during the period of time controlled by the timing mechanism.

17. The method of claim 16, further comprising:
adjusting an amplitude of the carrier signal to adjust an amount of power utilized to create the corona discharge.

18. The method of claim 17, further comprising:
adjusting a frequency of the carrier signal to match a coil assembly utilized to produce the corona discharge.

19. An apparatus for producing a corona discharge comprising:
a voltage controlled oscillator for producing an audio signal at a first frequency;
a ramp generator for gradually increasing voltage supplied to the voltage controlled oscillator causing the audio signal to gradually increase from the first frequency to a final frequency;
an operational amplifier coupled to the ramp generator and coupled to the voltage controlled oscillator, wherein the operational amplifier supplies increased voltage produced by the ramp generator to the voltage controlled oscillator; and
a modulator for producing a carrier signal to carry the audio signal produced by the voltage controlled oscillator, wherein the carrier signal is of a frequency higher than the frequency of the audio signal and modulated by the audio signal.

20. The apparatus of claim 19, further comprising:
a gating mechanism coupled to the modulator, wherein the gating mechanism allows pass-through of the modulated carrier signal produced by the modulator;
a MOSFET driver coupled to the gating mechanism for storing the modulated carrier signal passed through from the gating mechanism;
a coil assembly coupled to the MOSFET driver for receiving the modulated carrier signal, wherein the coil assembly is matched to the frequency of the modulated carrier signal and steps up the voltage of the modulated signal; and
a discharge pin coupled to the coil assembly for discharging an electrical charge produced by the coil assembly, wherein the electrical charge ionizes the surrounding air to produce a corona discharge.
